(19) United States
(12) Patent Application Publication
(10) Pub. No.: US 2026/0161540 A1
(43) Pub. Date: Jun. 11, 2026

(54) SYSTEM AND METHOD FOR DATA PLACEMENT FOR MATRIX MULTIPLICATION

(71) Applicant: Samsung Electronics Co., Ltd., Suwon-si (KR)

(72) Inventors: Ilgu HONG, Santa Clara, CA (US); Praveen KRISHNAMOORTHY, Fremont, CA (US); Ramzi AMMARI, Santa Clara, CA (US); Yangwook KANG, San Jose, CA (US)

(21) Appl. No.: 19/251,777

(22) Filed: Jun. 26, 2025

Related U.S. Application Data
(60) Provisional application No. 63/729,018, filed on Dec. 6, 2024.

(51) Int. Cl. G06F 12/02; G06F 9/50; G06F 15/80

(52) U.S. Cl. CPC G06F 12/0207; G06F 9/5027; G06F 15/80

(57) ABSTRACT

A system and method for data placement for matrix multiplication. In some embodiments, a method includes storing a tile of a tensor in a memory of an accelerator, the storing including: rearranging the tile to generate a rearranged tile, and storing a first vector of the tile and a second vector of the tile in contiguous memory locations.

### CROSS-REFERENCE TO RELATED APPLICATION(S)

The present application claims priority to and the benefit of U.S. Provisional Application No. 63/729,018, filed Dec. 6, 2024, entitled “DATA PLACEMENT METHOD FOR NEAR MEMORY WITH ACTIVATION STAGED SYSTOLIC GENERAL MATRIX MULTIPLICATION (GEMM) ENGINE”, the entire content of which is incorporated herein by reference.

### FIELD

One or more aspects of embodiments according to the present disclosure relate to computation, and more particularly to a system and method for data placement for matrix multiplication.

### BACKGROUND

Matrix multiplication involving relatively large matrices may be used in various applications, including machine learning applications such as neural network inference operations.

It is with respect to this general technical environment that aspects of the present disclosure are related.

The above information disclosed in this Background section is only for enhancement of understanding of the background and therefore the information discussed in this Background section does not necessarily constitute prior art.

### SUMMARY

According to an embodiment of the present disclosure, there is provided a method, including: storing a tile of a tensor in a memory of an accelerator, the storing including: rearranging the tile to generate a rearranged tile, and storing a first vector of the tile and a second vector of the tile in contiguous memory locations.

In some embodiments, the method further includes: storing the first vector and the second vector in a first portion of the memory, the first portion of the memory being an activation unit of the memory.

In some embodiments, the method further includes selecting a first dimension of the tile and a second dimension of the tile.

In some embodiments: the memory is connected to an array accelerator; the array accelerator includes a two-dimensional array of processing circuits; the array of processing circuits has a first dimension and a second dimension; and the selecting includes setting a first dimension of the tile equal to an integer multiple of the first dimension of the array of processing circuits.

In some embodiments, the selecting further includes setting the first dimension of the tile equal to an integer fraction of a maximum first dimension value, the maximum first dimension value being a value of the first dimension at which a size of the tile equals a capacity of the first portion of the memory.

In some embodiments: the selecting further includes setting the first dimension equal to a ratio of: a product of a first dimension of the tensor and a group number; and a product of a number of processing elements of the accelerator and a number of iterations, the group number is equal to a ratio of a capacity of the first portion of the memory to the size of the tile, and the number of iterations is a number of submatrix-product calculations used to calculate a partial product for the tile.

In some embodiments, the number of iterations equals 1.

In some embodiments, the group number equals 1.

In some embodiments, the storing includes transposing the tile.

According to an embodiment of the present disclosure, there is provided a non-transitory computer-readable medium including instructions that, when executed by a processing circuit, cause the processing circuit to perform a method, the method including. storing a tile of a tensor in a memory of an accelerator, the storing including: rearranging the tile to generate a rearranged tile, and storing a first vector of the tile and a second vector of the tile in contiguous memory locations.

In some embodiments, the method further includes: storing the first vector and the second vector in a first portion of the memory, the first portion of the memory being an activation unit of the memory.

In some embodiments, the method further includes selecting a first dimension of the tile and a second dimension of the tile.

In some embodiments: the memory is connected to an array accelerator; the array accelerator includes a two-dimensional array of processing circuits; the array of processing circuits has a first dimension and a second dimension; and the selecting includes setting a first dimension of the tile equal to an integer multiple of the first dimension of the array of processing circuits.

In some embodiments, the selecting further includes setting the first dimension of the tile equal to an integer fraction of a maximum first dimension value, the maximum first dimension value being a value of the first dimension at which a size of the tile equals a capacity of the first portion of the memory.

In some embodiments: the selecting further includes setting the first dimension equal to a ratio of: a product of a first dimension of the tensor and a group number; and a product of a number of processing elements of the accelerator and a number of iterations, the group number is equal to a ratio of a capacity of the first portion of the memory to the size of the tile, and the number of iterations is a number of submatrix-product calculations used to calculate a partial product for the tile.

In some embodiments, the number of iterations equals 1.

In some embodiments, the group number equals 1.

In some embodiments, the storing includes transposing the tile.

According to an embodiment of the present disclosure, there is provided a system, including: a host; and an accelerator, connected to the host, the host being configured to store a tile of a tensor in a memory of the accelerator, the storing including: rearranging the tile to generate a rearranged tile, and storing a first vector of the tile and a second vector of the tile in contiguous memory locations.

In some embodiments, the host is further configured to: store the first vector and the second vector in a first portion of the memory, the first portion of the memory being an activation unit of the memory.

### BRIEF DESCRIPTION OF THE DRAWINGS

These and other features and advantages of the present disclosure will be appreciated and understood with reference to the specification, claims, and appended drawings wherein:

FIG. 1A is a system level block diagram, according to an embodiment of the present disclosure;

FIG. 1B is a block diagram of a host and an accelerator for performing near-memory computing, according to an embodiment of the present disclosure;

FIG. 1C is a diagram of an interleaved memory address space based on a block size (e.g., 16 KB) which may be referred to as a processing element unit size (PE unit size), according to an embodiment of the present disclosure;

FIG. 1D is a block diagram of a portion of a general matrix multiplication engine, according to an embodiment of the present disclosure;

FIG. 2A is a diagram of submatrix multiplication, according to an embodiment of the present disclosure;

FIG. 2B is a data layout diagram showing tiling and grouping, according to an embodiment of the present disclosure;

FIG. 2C is a data layout diagram showing reshaping, according to an embodiment of the present disclosure;

FIG. 2D is a data layout diagram showing data placement based on a transpose tensor, according to an embodiment of the present disclosure;

FIG. 2E is a data layout diagram showing data placement in the memory based on the transpose tensor, according to an embodiment of the present disclosure;

FIG. 2F is a data layout diagram showing the placement of data corresponding to two iterations, according to an embodiment of the present disclosure;

FIG. 2G is a data layout diagram showing data placement in the memory for the two iterations, according to an embodiment of the present disclosure;

FIG. 3A is a data layout diagram showing tile locations within a tensor prior to data placement, according to an embodiment of the present disclosure;

FIG. 3B is a data layout diagram showing tile locations within the memory after data placement, according to an embodiment of the present disclosure; and

FIG. 4 is a flow chart, according to an embodiment of the present disclosure.

### DETAILED DESCRIPTION

The detailed description set forth below in connection with the appended drawings is intended as a description of exemplary embodiments of a system and method for data placement for matrix multiplication provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Matrix multiplications may be performed extensively in machine learning (e.g., neural network) operations. For example, in both neural network training and neural network inference operations a first matrix, e.g., a two-dimensional tensor of activations, may be multiplied (in a matrix multiplication) by a second matrix, e.g., a two-dimensional tensor of weights, to obtain a product matrix, as part of the process of calculating the output of an artificial neuron, the input to which may be the set of activations.

Such matrix multiplications may be performed by first dividing the first matrix, or the second matrix, or both, into submatrices, or “tiles” that may be more efficiently processed by a computing system calculating the matrix product. In such an embodiment, each tile of the first matrix may be multiplied (in a matrix multiplication) by a tile of the second matrix, to generate a tile of partial products of the result matrix. This tile of partial products may then be summed with other tiles of partial products to obtain the tile of the product matrix.

Each matrix multiplication may be performed by calculating dot products of the row vectors of the first matrix (or of a tile of the first matrix) with column vectors of the second matrix (or of a tile of the second matrix). Each such vector may be read from memory into a processing circuit (e.g., in one operation, or one element at a time) in order for the processing circuit to perform the element-by-element multiplications, and accumulations of the resulting products, that are parts of the computation of each dot product. As used herein, a “vector” of a matrix is a row of the matrix or a column of the matrix.

Reading data from memory may involve first activating a set of bits of the memory, e.g., a word line if the memory includes or consists of dynamic random-access memory (DRAM). The smallest set of bits that may be activated at one time (e.g., a word line, or a row (which may be activated by a row activation), in the case of DRAM) may be referred to as an “activation unit” (or “activation word line”, or “activation bit group”) of the memory. The activation of an activation unit of the memory may consume energy each time it is performed.

If the elements of a matrix are stored in row-major order in memory, then a first row of a tile of the matrix may be stored in a first set of consecutive memory locations, and the next row of the tile may be stored in a second set of consecutive memory locations, separated from the first set of consecutive memory locations by intervening elements of other tiles. As such, if the tile is read from memory one row at a time (or if all of the rows are read at once), and if a row of the matrix is larger than an activation unit of the memory, multiple activations may be used to read the tile from memory, and each such activation may activate bits that are not in the tile and that are not then read (as part of the read operation). Similarly, if the tile is read from memory one column vector at a time, then consecutive elements of each column vector may be separated from each other by intervening elements of other tiles. During the read operation, some of these other elements may be activated but not read. As such, performing a matrix multiplication using a tile that is part of a matrix stored in row-major order in memory may be energy-inefficient, because the activation of bits that are not read incurs an energy cost part of which does not result in data retrieval. An analogous analysis may show that similar inefficiency may be present if the matrix is stored in column-major order.

Activations of bits that are not then read may also result in inefficiencies in a general-purpose graphics processing unit (GPU). For example in a general-purpose graphics processing unit, a tensor may be stored in a contiguous set of memory locations, so that a tile may be fragmented across multiple DRAM rows, and reading out of a row of the tile may be energy inefficient, because, e.g., it may involve activating a word line containing both the tile row to be read and tile rows that are parts of other tiles, and which are not needed at the same time.

As such, in some embodiments, all of the elements of a tile may be stored in consecutive memory locations, so that the activation of any activation unit that fully overlaps the tile will activate only bits that are then read, resulting in full productive use of the energy expenditure required for that activation. Further, in some embodiments, the tile size is chosen so that the tile size equals the capacity of the activation unit and each activation unit stores exactly one entire tile, which may be read out all at once; in such an embodiment, there are no activation units straddling a tile boundary (the reading of which may not make full productive use of the energy expenditure required for its activation). In some embodiments, the tile size is chosen to be an integer fraction of the capacity of the activation unit and each activation unit stores an integer number of tiles, which may be read out all at once. In such an embodiment, it may also be the case that there are no activation units straddling a tile boundary (the reading of which may not make full productive use of the energy expenditure required for its activation).

In some embodiments the second matrix of a matrix product, or the tiles of the second matrix, may be stored in transpose order, e.g., the elements of each column may be stored in consecutive memory locations, so that the calculating of a dot product (which may involve element-wise products of a row of the first matrix and a column of the second matrix) is more efficient, because the elements of the row of the first matrix are stored in consecutive memory locations, and readily read out all at once, and the elements of the column of the second matrix are also stored in consecutive memory locations, and readily read out all at once.

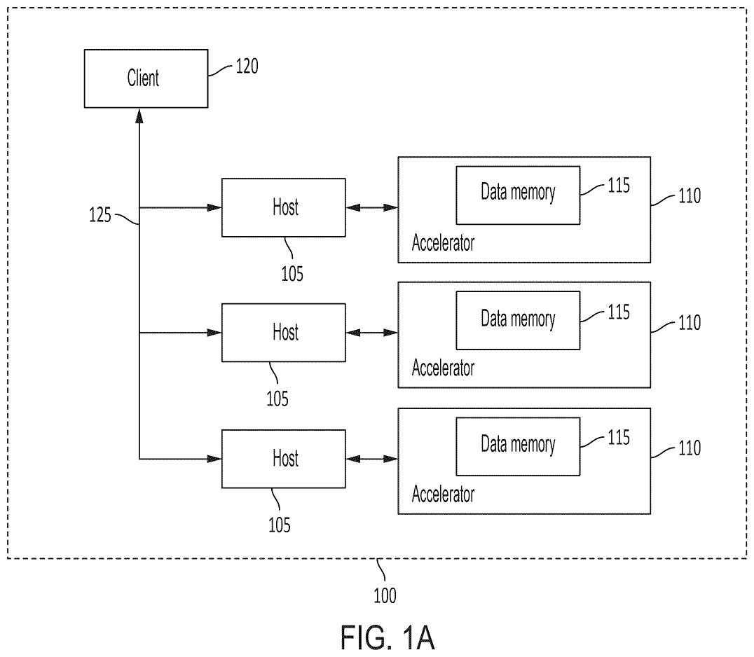

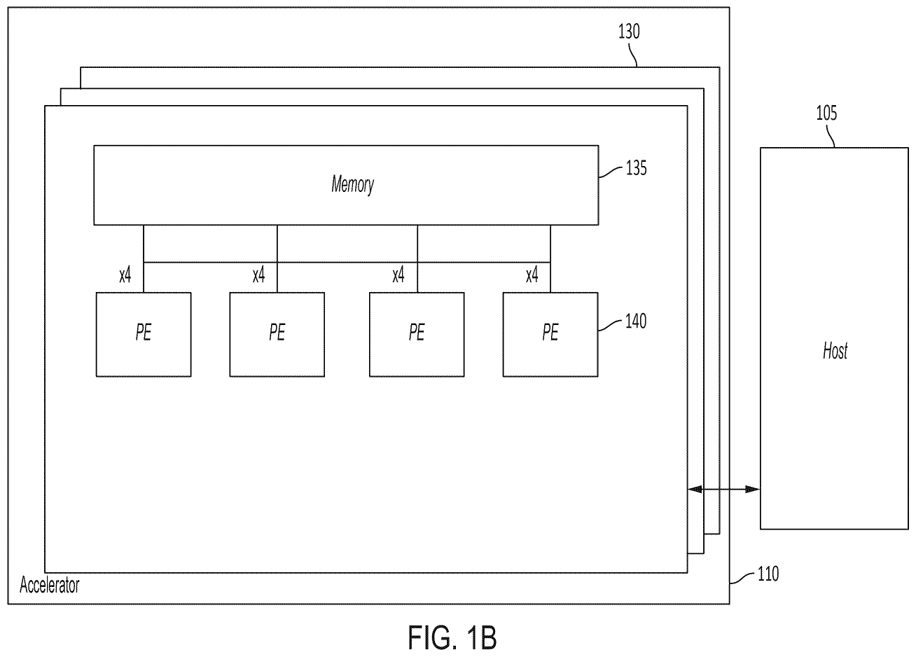

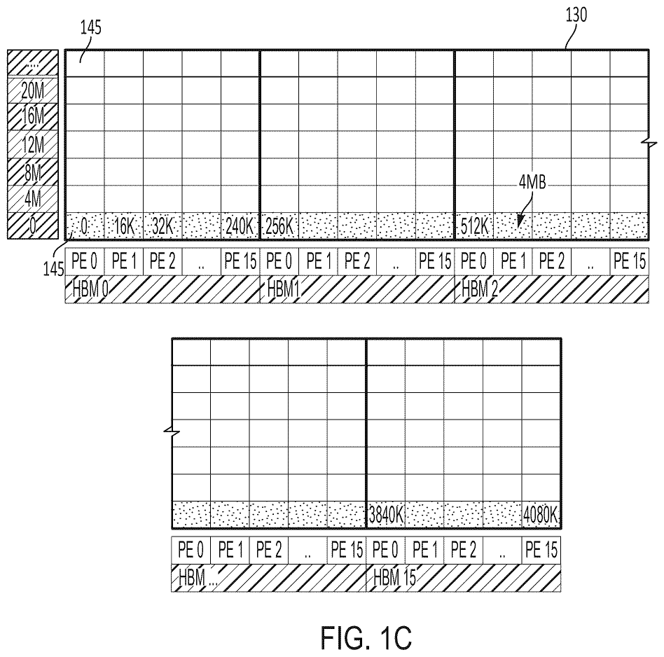

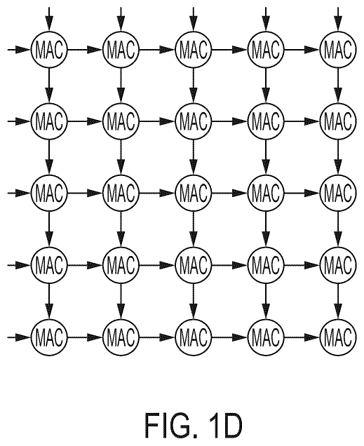

FIG. 1A is a block diagram of a computing system 100. The computing system 100 may include one or more hosts 105. Each host 105 controls, and uses, a corresponding accelerator 110 (e.g., a tensor calculation accelerator) to perform calculations such as convolution operations. During this process, the host 105 may write (e.g., using direct memory access (DMA)) operands to a data memory 115 of the accelerator 110, the host 105 may send commands to the accelerator 110 to perform certain operations (e.g., a two-dimensional convolution operation) on the operands, and the host 105 may, after the operations are complete, read the results (e.g., the output) from the data memory 115 of the accelerator 110.

A client 120, which may be connected to the host 105 through a network 125 (e.g., via a wired or wireless communication protocol), may send requests (e.g., for higher-level artificial intelligence operations) to the host 105, and receive results from the host 105. As illustrated in FIG. 1A, the client 120 may be connected to a plurality of hosts 105 providing similar services. Accordingly, the client 120 may send, for example, a request to perform image classification, the request including an image, to a first host 105, and the host may perform the image classification, e.g., using an accelerator 110 to perform tensor operations (e.g., array multiplications) to perform the image classification.

FIG. 1B shows an accelerator 110 connected to a host 105. The accelerator 110 may include a plurality of memory cards 130, each of which may be a high-bandwidth memory (HBM). Each memory card 130 may include a memory 135 and a plurality of processing elements 140. FIG. 1B shows four processing elements 140 on a memory card 130; in some embodiments each memory card 130 may include more or fewer processing elements 140. For example, in some embodiments, an accelerator 110 may include 16 memory cards 130 (each of which may itself be an accelerator) and each memory card 130 may include 16 processing elements 140, so that the accelerator 110 includes a total of 256 processing elements 140. Each processing element (PE) 140 may be or include a processing circuit (discussed in further detail below).

FIG. 1C shows the organization of the memory 135 of an accelerator 110 with 16 memory cards 130 (HBM 0-HBM 15), each with 16 processing elements 140 (PE 0-PE 15), in some embodiments. The memory 135 includes blocks that may be referred to as processing element units (or PE units) 145, each of which may have a size of 16 kilobytes (KB), each of which may be an activation unit, and each of which may be allocated to a respective one of the processing elements 140. The addresses may be interleaved in the sense that addresses 0 through 16k−1 may be within the first PE unit 145 (shown at lower left in the array of PE units 145 of FIG. 1C), which is connected to processing element 0 (PE 0), addresses 16k through 32k−1 may be within the second PE unit 145 (shown at lower left in the array of PE units 145 of FIG. 1C), which is connected to processing element 1 (PE 1), and so forth, for the first 4080k addresses. The 17^{th} PE unit 145, which is connected to processing element 0 (PE 0) and which is shown immediately above the first PE unit 145, may contain memory with a set of addresses extending from 4080k to 4080k+16k−1, and so forth. Each processing element 140 may include a processing circuit that may be referred to as a general matrix multiplication engine (GEMM engine). The GEMM engine may include a plurality of multiply and accumulate (MAC) units arranged in a two-dimensional array, as shown in FIG. 1D.

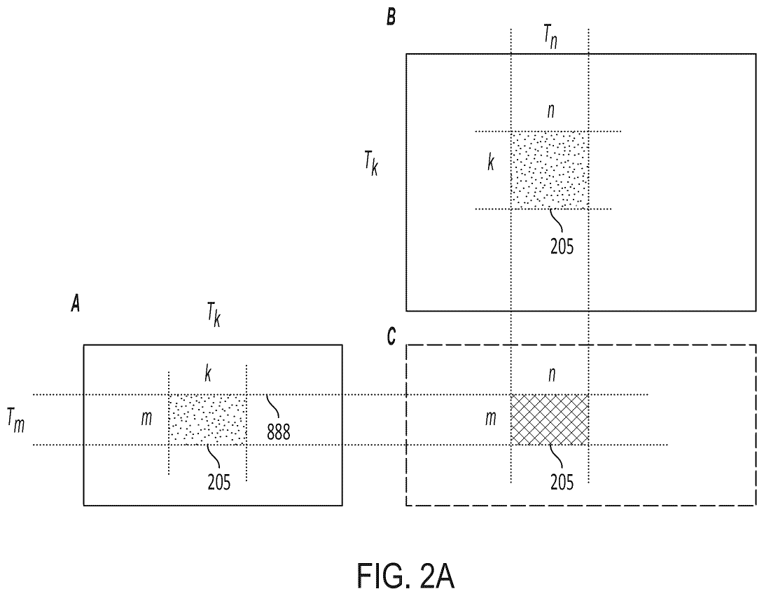

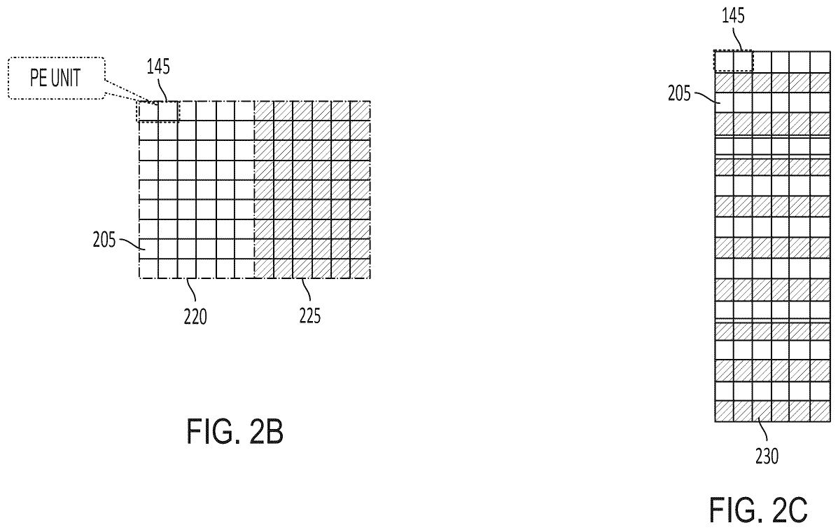

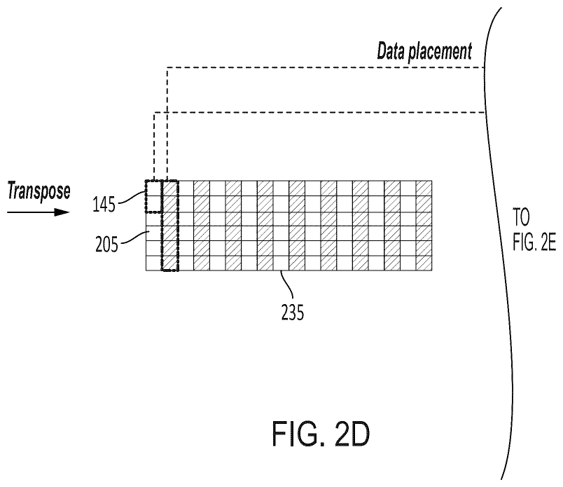

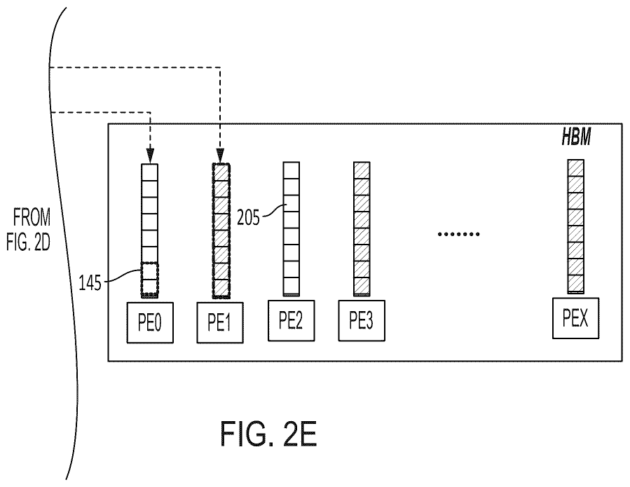

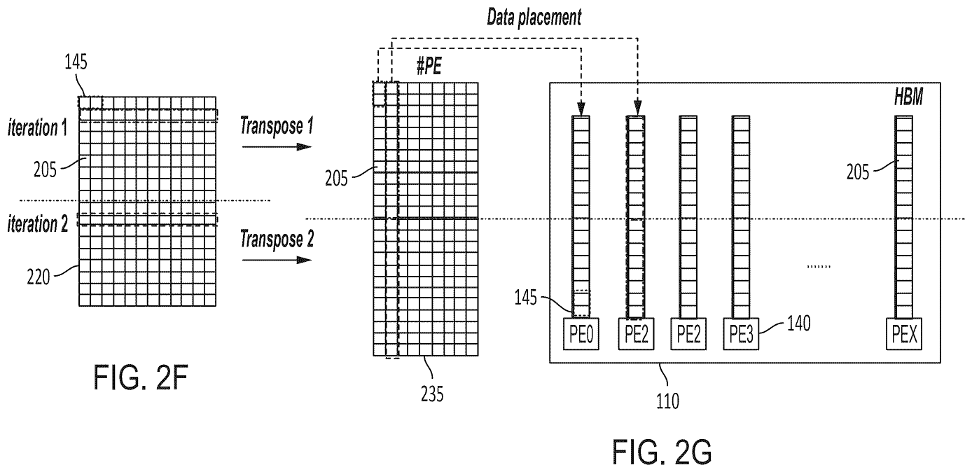

FIG. 2A illustrates the matrix multiplication of a tile of a first matrix (the matrix A) with a tile 205 of a second matrix (the matrix B) to form a tile 205 of a product matrix (the matrix C). As mentioned above, in some embodiments, the dimensions of the tiles 205 into which a tensor (e.g., a matrix) is divided for performing a piece-wise matrix multiplication are selected for efficient memory read access.

Examples of how the tile size may be chosen, and how each tile may be placed into a memory (e.g., the memory 135) are given below. Calculations described herein are in units of elements (e.g., units of two bytes, if each element occupies two bytes) unless otherwise specified. As such, if the element size is two bytes, and the PE unit memory size is 16 KB, then the PE unit size is 8k (e.g., 8192). As used herein, “k”, when used as a unit or part of a unit, means 1024. For example, 8k means 8192. The size of a PE unit, as a number of elements (e.g., two-byte numbers) that it is capable of storing, may be referred to herein as the PE unit size, or as the capacity of the PE unit. The size of a PE unit in bytes may be referred to herein as the PE unit memory size.

As mentioned above, Each processing element 140 may include a processing circuit that may be referred to as a general matrix multiplication engine (GEMM engine), and which may include a plurality of multiply and accumulate (MAC) units arranged in a two-dimensional array, as shown in FIG. 1D. The GEMM engine may perform matrix multiplications (e.g., of tiles) by reading in a plurality of row vectors of length k and a plurality of column vectors of length k, and calculating dot products in a parallelized manner. The array of MAC units of the GEMM engine may have dimensions of m×n. The size k of the vectors and m may be fixed, and n may be adjustable by reconfiguration of the GEMM engine. As such, the fixed values of k and m may constrain the selection of tile sizes.

The examples given below are discussed in the context of a weight tensor, which may in some embodiments be larger than the activation tensor with which it is to be multiplied. Analogous tile size selection and tile placement methods may be used for an activation tensor, except possibly for the step (discussed below) of transposing the tensor (as the elements of the row vectors of the activation tensor may already be stored in consecutive memory locations if the tensor is not transposed).

As mentioned above, it may be advantageous for an integer number of tiles to fit into a PE unit. FIG. 2B shows an example of a tensor with tiles each having a size that is half of the PE unit size, so that two tiles fit into each PE unit. Two tensors, a first tensor 220 and a second tensor 225 (each divided into a plurality of tiles) may be processed concurrently, by the processing elements 140. This circumstance (in which two tiles fit into a PE unit) may correspond to a group number of two (discussed in further detail below). In FIG. 2B, each of the small squares is a tile 205, and the rectangle at upper left is an example of a PE unit 145.

The following method may be used to select a tile size and place the data from a tensor into memory. The method is illustrated using an example in which the transpose weight tensor W^{T} has dimensions |Tₙ×Tₖ|, the GEMM engine (which performs two-byte (e.g., 16-bit floating point (FP16)) operations) has dimensions of m×k, where m=8 and k=32, the PE unit memory size is 16 KB, the PE unit size is 8k, and the number of PEs in the accelerator is 256 (e.g., the accelerator includes 16 memory cards 130 with 16 PEs on each memory card 130. As used herein, the notation |Tₙ×Tₖ| (or |Tₙ, Tₖ|) means a two-dimensional tensor having dimensions Ty and TR. Similarly |D₁, D₂, D₃, . . . . Dₙ| means an n-dimensional tensor with dimensions D₁, D₂, D₃, . . . . Dₙ.

In some embodiments, the tile size, which may be n×k, may be selected in a first operation as follows. The variable n_{w}, which may be a maximum value of n for which a tile will fit into a PE unit, may be calculated by setting the PE unit size equal to n_{w}×k. For example, if k is 32 and the PE unit size is 8k, then n_{w}=8k/32=256, and the maximum value for n is 256. The value of n may also be selected to meet a criterion (which may be referred to as a “fitting criterion”) which may be met when n is selected to be an integer multiple of m and n is selected such that n_{w} is divisible by (e.g., an integer multiple of) n. Meeting the fitting criterion may avoid having a tile cross a PE unit boundary.

A first tentative value for n, ñ, may be calculated as the ratio

$$\frac{{T}_{n}}{\# PE} ,$$

where #PE (which may also be written #pe) is the number of processing elements 140 in the accelerator (e.g., 256, in an embodiment with 16 memory cards 130, each with 16 processing elements 140). The method may further involve checking whether ñ meets the fitting criterion; if ñ meets the fitting criterion, then ñ may be used as the value for n.

If the first tentative value ñ does not meet the fitting criterion (e.g., if ñ is less than 8), then a second (larger) tentative value for ñ may be calculated as

$$\frac{{T}_{n}}{( \frac{\# PE}{{2}^{l}} )} = \tilde{n} ,$$

with l a positive integer. If this value of n meets the fitting criterion, then n may be used as the value for n, and a group number g, which indicates the number of tiles to be processed at the same time, may be set to be equal to 2^{l}. The selected value of l may be the smallest value that results in a value of n that meets the fitting criterion.

If the second tentative value ñ does not meet the fitting criterion then a third tentative value for ñ may be calculated as

$$\tilde{n} = \frac{{T}_{n}}{( \frac{\# PE}{{2}^{l}} ) i}$$

with both l and i being positive integers, with 2^{l} being the group number, and i being the number of iterations (e.g., the number of separate submatrix-product calculations used to calculate the partial product for each tile).

The variable tc may represent the tile count, or the number of tiles stored in each PE unit, which may be equal to

$$\frac{{n}_{w}}{n} .$$

Once the tile dimensions have been selected, the tensor may be represented as a collection of (e.g., as an array of) tiles. For example, the two-dimensional tensor W^{T}, which may be represented as |Tₙ×Tₖ| may be reformatted as a four dimensional tensor:

$$\vert {T}_{n} \times {T}_{k} \vert \to \vert \hat{N} , \hat{K} , n , k \vert$$

with

$$\hat{N} = \frac{{T}_{n}}{n} and \overline{K} = \frac{{T}_{k}}{k} .$$

This tensor is a two-dimensional, \hat{N}×\hat{K}, array of tiles, each tile being a two-dimensional, n×k, array of elements. The reformatting may be performed, for example, by a transformation using the following PyTorch instruction:

$$w = \vert {T}_{n} \times {T}_{k} \vert \to w . reshape ( \hat{N} , n , \hat{K} , k ) . transpose ( 0 , 1 , 2 , 3 ) \to \vert \hat{N} , \hat{K} , n , k \vert$$

The tensor may then be serialized, to change its dimensions as follows:

$$\vert \hat{N} , \hat{K} , n , k \vert \to \vert ( \hat{N} \times g ) , ( \hat{K} / ( g \times tc ) ) , ( tc \times n \times k ) \vert$$

This serialization may be performed using the following PyTorch instructions:

$$w = \vert \hat{N} , \hat{K} , n , k \vert \to w . reshape ( \hat{N} , g , ( \hat{K} / g ) , ( n \times k ) ) . reshape ( ( \hat{N} \times g ) , ( \hat{K} / ( g \times tc ) ) , tc , ( n \times k ) )$$

$$and$$

$$w = \vert ( \hat{N} \times g ) , ( \hat{K} / ( g \times tc ) ) , tc , ( n \times k ) \vert \to w . reshap e ( ( \hat{N} \times g ) , ( \hat{K} / ( g \times tc ) ) , ( tc \times n \times k ) ) .$$

Serialization of two tensors is illustrated in FIG. 2C, in which the first tensor 220 and the second tensor 225 (FIG. 2B), each divided into (e.g., consisting of) an array of tiles, are serialized to form a single serialized tensor 230. The serialized tensor 230 includes (e.g., consists of) alternating rows of tiles of the first tensor 220 and of the second tensor 225. The serialization may result in full utilization of the computational power of all processing elements 140, and may reduce computation time by enabling parallel execution.

The serialized tensor may then be transposed so that the column vectors of the tile (which are to be multiplied, in dot products, with the row vectors of the activation tensor) are stored as rows in memory (e.g., in consecutive memory locations), facilitating the concurrent retrieval of consecutive elements of a row vector of an activation tensor and the corresponding consecutive elements of a column vector of a weight tensor. This is illustrated in FIG. 2D, and in FIG. 2G (discussed below), each which illustrates transposed tensors 235 generated from a serialized tensor generated from two tensors (FIG. 2D) or from a single tensor 220 (FIG. 2G).

The transpose operation may be performed using the following PyTorch instructions, using a tensor |(N×g/#pe), #pe, (R/(g×tc)), (tc×n×k)| that may be obtained by reformatting for iterations (discussed in further detail below):

$$w = \vert ( \hat{N} \times g / \# pe ) , \# pe , ( \hat{K} / ( g \times tc ) ) , ( tc \times n \times k ) \vert \to w . transpose ( 0 , 2 , 1 , 3 )$$

$$w = \vert ( \hat{N} \times g / \# pe ) , ( \hat{K} / ( g \times tc ) ) , \# pe , ( tc \times n \times k ) \vert .$$

FIGS. 2F and 2G show the handling of iterations, in some embodiments. FIG. 2F shows a tensor processed during two iterations, with one half of the tiles of the tensor processed during each iteration. These operations may be performed using the tensor |(Ñ×g), (R/(g×tc)), (tc×n×k)|→|(N×g/#pe), #pe, (\hat{K}/(g×tc)), (tc×n×k)| and using the following PyTorch instructions:

$$w = \vert ( \hat{N} \times g ) , ( \hat{K} / ( g \times tc ) ) , ( tc \times n \times k ) \vert \to w . reshape ( ( \hat{N} \times g / \# pe ) , \# pe , ( \hat{K} / ( g \times tc ) ) , ( tc \times n \times k ) )$$

FIG. 2G, shows the rearrangement of the tiles resulting from the transpose operation, and the placement of columns of tiles into PE units of respective processing elements 140.

The following numerical examples illustrate these methods. In a first example, W^{T} is |12288×8192|, the GEMM engine processes two-byte (FP16) elements and has dimensions (m×k) of |8×32|, the PE unit memory size is 16 kB, and #PE is 256

For determining the tile dimensions, the fitting criterion may be that n be a value such that m (8)<=n<=n_{w} (256), n be divisible by m (8), and n_{w} be divisible by n. It follows that

$${n}_{w} = 256$$

and the first tentative value for n, ñ, may be calculated as the ratio

$$\frac{{T}_{n}}{\# PE} ,$$

which is 12288/256=48; this does not meet the fitting criterion because 256 not divisible by 48.

The third tentative value for ñ may be calculated as

$$\tilde{n} = \frac{{T}_{n}}{( \frac{\# PE}{{2}^{l}} ) i}$$

with l=0 (g=1) and i=3:

$$\frac{{T}_{n}}{( \frac{\# PE}{{2}^{l}} )} = \tilde{n} \times i \to \frac{{T}_{n}}{i \times ( \frac{\# PE}{{2}^{l}} )} = \tilde{n} , 12288 / ( 3 \times 256 ) = 16$$

This results in:

$$n = 16 , g = 1 , iteration = 3 , tc = 16 \to \hat{N} = \frac{12288}{16} , \hat{K} = \frac{8192}{32}$$

which meets the fitting criterion.

In a second example, W^{T} is |8192×8192|, the GEMM engine processes two-byte (FP16) elements and has dimensions (m×k) of |8×32|, the PE unit memory size is 16 KB, and #PE is 256.

For determining the tile dimensions, the fitting criterion may be that n be a value such that m (8)<=n<=n_{w} (256), n be divisible by m (8), and n_{w} be divisible by n. It follows that

$${n}_{w} = 256$$

and the first tentative value for n, ñ, may be calculated as the ratio

$$\frac{{T}_{n}}{\# PE} ,$$

which is 8192/256=32.

This then results in n=32, g=1, iteration=1, which meets the fitting criterion; this implies tc=8,

$$\hat{N} = \frac{8192}{32} , and \hat{K} = \frac{8192}{32} .$$

In a third example, W^{T} is |1024×8192|, the GEMM engine processes two-byte (FP16) elements and has dimensions (m×k) of | 8×32|, the PE unit memory size is 16 kB, and #PE is 256.

For determining the tile dimensions, the fitting criterion may be that n be a value such that m (8)<=n<=n_{w} (256), n be divisible by m (8), and n_{w} be divisible by n. It follows that

$${n}_{w} = 256$$

and the first tentative value for n, ñ, may be calculated as the ratio

$$\frac{{T}_{n}}{\# PE} ,$$

which is 1024/256=4, which is less than m and as such does not meet the fitting criterion. The second tentative value may then be calculated as

$$\frac{{T}_{n}}{( \frac{\# PE}{{2}^{l}} )} = \tilde{n}$$

which yields 1024/(256/2)=8, n=8, g=2, iteration 1, which meets the fitting criterion; this implies tc=32,

$$\hat{N} = \frac{1024}{8} , and \hat{K} = \frac{8192}{32} .$$

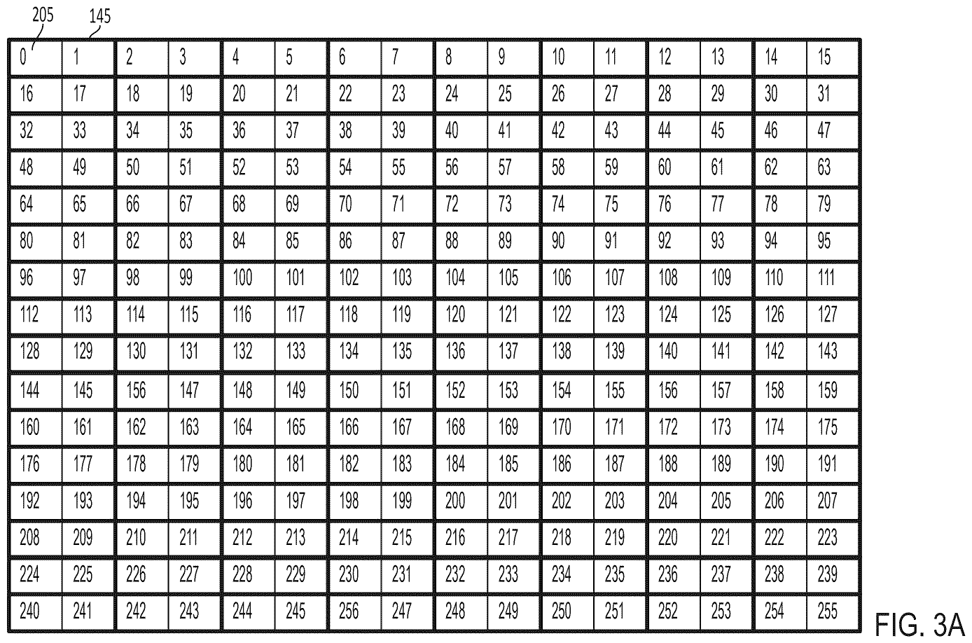

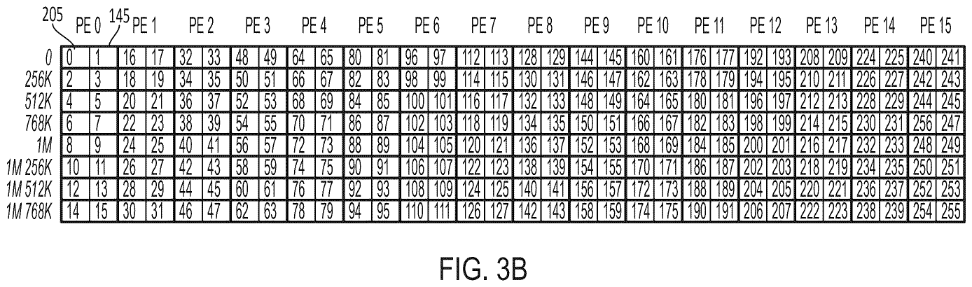

FIG. 3A shows a tensor divided into 256 tiles, numbered 0 through 255. In this example, the GEMM engine (which performs two-byte (e.g., 16-bit floating point (FP16)) operations) has dimensions of m×k, where m=8 and k=32, the PE unit memory size is 16 KB, the PE unit size is 8k, the number of PEs in the accelerator is 16, and the tensor W^{T} is |2048×512|. Then, using the methods described, the following parameter values may be used: n=2048, corresponding to a tile size of |128×32|, a tile count (per PE unit) of tc=2, a group count of g=1, and a number of iterations of I=1. FIG. 3B shows the same tensor, after reshaping and transposing. In the format shown in FIG. 3B, each column (consisting of a vertically stacked set of PE units 145) may be processed by a respective processing element 140; for example, the left-most column, which contains tiles 0 through 15, may be processed by PEO of a system like that of FIG. 1C.

Each of the drawings herein showing components of a system are examples only and analogous systems may include more or fewer elements; for example, components not illustrated in such a drawing may nonetheless be present in a system, in some embodiments.

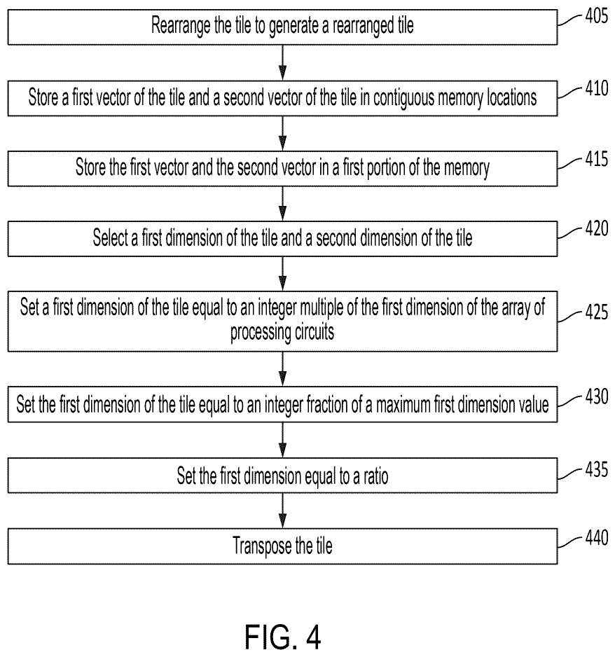

FIG. 4 shows a method of rearranging and placing data, in some embodiments. Although FIG. 4 illustrates various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

The method may include storing a tile of a tensor in a memory of an accelerator, the storing including: rearranging, at 405, the tile to generate a rearranged tile, and storing, at 410, a first vector of the tile and a second vector of the tile in contiguous memory locations. For example, as discussed above, if the row vectors of a tile (or, in some circumstances, the column vectors of a tile) are stored in contiguous sets of memory locations (without, e.g., intervening elements of other tiles), then the contiguous sets of memory locations may be within an activation unit of the memory, and it may be possible to read one or more vectors without activating bits of the memory that are not then read.

The method may further include storing, at 415, the first vector and the second vector in a first portion of the memory, the first portion of the memory being an activation unit of the memory. As mentioned above, the storing of such vectors in contiguous regions of memory may make it possible to fill an activation region (e.g., a PE unit 145) with data that is needed for a calculation, making it possible to avoid potentially wasteful activating of bits that are not then read. The method may further include selecting, at 420, a first dimension of the tile and a second dimension of the tile. As mentioned above, the tile dimensions may be selected such that each activation unit (e.g., each PE unit 145) fits an integer number of tiles, which fill the PE unit 145, making it possible to avoid activating bits of the memory that are not then read.

In some embodiments, the memory is connected to an array accelerator (e.g., to a GEMM engine), the array accelerator including a two-dimensional array of processing circuits (e.g., a two-dimensional array of MAC units), the array of processing circuits having a first dimension and a second dimension, the selecting including setting, at 425, a first dimension of the tile equal to an integer multiple of the first dimension of the array of processing circuits. For example, the fitting criterion may be met only if n is an integer multiple of m, which is one of the dimensions of the array of processing circuits (e.g., the array of MAC units) of the GEMM engine.

In some embodiments, the selecting further includes setting, at 430, the first dimension of the tile equal to an integer fraction of a maximum first dimension value (e.g., to an integer fraction of n_{w}), the maximum first dimension value (e.g., n_{w}) being a value of the first dimension at which a size of the tile equals a capacity of the first portion of the memory.

In some embodiments, the selecting further includes setting, at 435, the first dimension equal to a ratio. The ratio may be the ratio of: a product of a first dimension of the tensor and a group number; and a product of a number of processing elements of the accelerator and a number of iterations. For example, such a product may be the third tentative value

$$\frac{{T}_{n}}{( \frac{\# PE}{{2}^{l}} ) i} = \frac{{T}_{n} {2}^{l}}{\# PEi} ,$$

where the first dimension of the tensor and the group number are Tₙ and 2^{l} respectively, and where the processing elements of the accelerator and the number of iterations are #PE and i respectively. The group number may be equal to a ratio of a capacity of the first portion of the memory to the size of the tile, and the number of iterations may be a number of submatrix-product calculations (e.g., calculations of the matrix multiplication products of tiles) used to calculate a partial product for the tile. In some embodiments, the number of iterations equals 1, in which case the second tentative value reduces to the first tentative value. In some embodiments, the group number equals 1, in which case (if the number of iterations also equals 1) the third tentative value reduces to the first tentative value. In some embodiments, the storing includes transposing the tile, at 440.

In some embodiments, each system and method disclosed herein improves the functioning of a computer or improves another technology or technical field and, as such, each such system or method is integrated into a practical application. For example, the storing of a first vector of the tile and a second vector of the tile in contiguous memory locations makes it possible for the system to perform a read operation without activating bits that are not then read. This may improve the energy efficiency of the computer (e.g., of the accelerator 110) and it may further improve the technology of machine learning, and of neural network processing.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Some embodiments may include features of the following numbered statements.

1. A method, comprising:
storing a tile of a tensor in a memory of an accelerator,
the storing comprising:
   rearranging the tile to generate a rearranged tile, and
   storing a first vector of the tile and a second vector of the tile in contiguous memory locations.

2. The method of statement 1, further comprising:
storing the first vector and the second vector in a first portion of the memory,
the first portion of the memory being an activation unit of the memory.

3. The method of statement 1 or statement 2, further comprising selecting a first dimension of the tile and a second dimension of the tile.

4. The method of any one of the preceding statements, wherein:
the memory is connected to an array accelerator;
the array accelerator comprises a two-dimensional array of processing circuits;
the array of processing circuits has a first dimension and a second dimension; and
the selecting comprises setting the first dimension of the tile equal to an integer multiple of the first dimension of the array of processing circuits.

5. The method of any one of the preceding statements, wherein the selecting further comprises setting the first dimension of the tile equal to an integer fraction of a maximum first dimension value, the maximum first dimension value being a value of the first dimension at which a size of the tile equals a capacity of the first portion of the memory.

6. The method of any one of the preceding statements, wherein:
the selecting further comprises setting the first dimension equal to a ratio of:
   a product of
      a first dimension of the tensor and
      a group number; and
   a product of
      a number of processing elements of the accelerator and
      a number of iterations,
   the group number is equal to a ratio of a capacity of the first portion of the memory to the size of the tile, and
   the number of iterations is a number of submatrix-product calculations used to calculate a partial product for the tile.

7. The method of statement 6, wherein the number of iterations equals 1.

8. The method of statement 6, wherein the group number equals 1.

9. The method of any one of the preceding statements, wherein the storing comprises transposing the tile.

10. A non-transitory computer-readable medium comprising instructions that, when executed by a processing circuit, cause the processing circuit to perform a method, the method comprising.
storing a tile of a tensor in a memory of an accelerator,
the storing comprising:
   rearranging the tile to generate a rearranged tile, and
   storing a first vector of the tile and a second vector of the tile in contiguous memory locations.

11. The non-transitory computer-readable medium of statement 10, wherein the method further comprises:
storing the first vector and the second vector in a first portion of the memory,
the first portion of the memory being an activation unit of the memory.

12. The non-transitory computer-readable medium of statement 10 or statement 11, wherein the method further comprises selecting a first dimension of the tile and a second dimension of the tile.

13. The non-transitory computer-readable medium of any one of statements 10 to 12, wherein:
the memory is connected to an array accelerator;
the array accelerator comprises a two-dimensional array of processing circuits;
the array of processing circuits has a first dimension and a second dimension; and
the selecting comprises setting the first dimension of the tile equal to an integer multiple of the first dimension of the array of processing circuits.

14. The non-transitory computer-readable medium of any one of statements 10 to 13, wherein the selecting further comprises setting the first dimension of the tile equal to an integer fraction of a maximum first dimension value, the maximum first dimension value being a value of the first dimension at which a size of the tile equals a capacity of the first portion of the memory.

15. The non-transitory computer-readable medium of any one of statements 10 to 14, wherein:

the selecting further comprises setting the first dimension equal to a ratio of:
a product of
   a first dimension of the tensor and
   a group number; and
a product of
   a number of processing elements of the accelerator and
   a number of iterations,
the group number is equal to a ratio of a capacity of the first portion of the memory to the size of the tile, and
the number of iterations is a number of submatrix-product calculations used to calculate a partial product for the tile.

16. The non-transitory computer-readable medium of statement 15, wherein the number of iterations equals 1.

17. The non-transitory computer-readable medium of statement 15, wherein the group number equals 1.

18. The non-transitory computer-readable medium of any one of statements 10 to 17, wherein the storing comprises transposing the tile.

19. A system, comprising:
a host; and
an accelerator, connected to the host,
the host being configured to
store a tile of a tensor in a memory of the accelerator,
the storing comprising:
   rearranging the tile to generate a rearranged tile, and
   storing a first vector of the tile and a second vector of the tile in contiguous memory locations.

20. The system of statement 19, wherein the host is further configured to:
store the first vector and the second vector in a first portion of the memory,
the first portion of the memory being an activation unit of the memory.

Although exemplary embodiments of a system and method for data placement for matrix multiplication have been specifically described and illustrated herein, many modifications and variations will be apparent to those skilled in the art. Accordingly, it is to be understood that a system and method for data placement for matrix multiplication constructed according to principles of this disclosure may be embodied other than as specifically described herein. The invention is also defined in the following claims, and equivalents thereof.

What is claimed is:

1. A method, comprising:
storing a tile of a tensor in a memory of an accelerator,
the storing comprising:
rearranging the tile to generate a rearranged tile, and
storing a first vector of the tile and a second vector of the tile in contiguous memory locations.

2. The method of claim 1, further comprising:
storing the first vector and the second vector in a first portion of the memory,
the first portion of the memory being an activation unit of the memory.

3. The method of claim 2, further comprising selecting a first dimension of the tile and a second dimension of the tile.

4. The method of claim 3, wherein:
the memory is connected to an array accelerator;
the array accelerator comprises a two-dimensional array of processing circuits;
the array of processing circuits has a first dimension and a second dimension; and
the selecting comprises setting the first dimension of the tile equal to an integer multiple of the first dimension of the array of processing circuits.

5. The method of claim 4, wherein the selecting further comprises setting the first dimension of the tile equal to an integer fraction of a maximum first dimension value, the maximum first dimension value being a value of the first dimension at which a size of the tile equals a capacity of the first portion of the memory.

6. The method of claim 5, wherein:
the selecting further comprises setting the first dimension equal to a ratio of:
a product of
a first dimension of the tensor and
a group number; and
a product of
a number of processing elements of the accelerator and
a number of iterations,
the group number is equal to a ratio of a capacity of the first portion of the memory to the size of the tile, and
the number of iterations is a number of submatrix-product calculations used to calculate a partial product for the tile.

7. The method of claim 6, wherein the number of iterations equals 1.

8. The method of claim 6, wherein the group number equals 1.

9. The method of claim 1, wherein the storing comprises transposing the tile.

10. A non-transitory computer-readable medium comprising instructions that, when executed by a processing circuit, cause the processing circuit to perform a method, the method comprising:
storing a tile of a tensor in a memory of an accelerator,
the storing comprising:
rearranging the tile to generate a rearranged tile, and
storing a first vector of the tile and a second vector of the tile in contiguous memory locations.

11. The non-transitory computer-readable medium of claim 10, wherein the method further comprises:
storing the first vector and the second vector in a first portion of the memory,
the first portion of the memory being an activation unit of the memory.

12. The non-transitory computer-readable medium of claim 11, wherein the method further comprises selecting a first dimension of the tile and a second dimension of the tile.

13. The non-transitory computer-readable medium of claim 12, wherein:
the memory is connected to an array accelerator;
the array accelerator comprises a two-dimensional array of processing circuits;
the array of processing circuits has a first dimension and a second dimension; and
the selecting comprises setting the first dimension of the tile equal to an integer multiple of the first dimension of the array of processing circuits.

14. The non-transitory computer-readable medium of claim 13, wherein the selecting further comprises setting the first dimension of the tile equal to an integer fraction of a maximum first dimension value, the maximum first dimension value being a value of the first dimension at which a size of the tile equals a capacity of the first portion of the memory.

15. The non-transitory computer-readable medium of claim 14, wherein:
the selecting further comprises setting the first dimension equal to a ratio of:
a product of
a first dimension of the tensor and
a group number; and
a product of
a number of processing elements of the accelerator and
a number of iterations,
the group number is equal to a ratio of a capacity of the first portion of the memory to the size of the tile, and
the number of iterations is a number of submatrix-product calculations used to calculate a partial product for the tile.

16. The non-transitory computer-readable medium of claim 15, wherein the number of iterations equals 1.

17. The non-transitory computer-readable medium of claim 15, wherein the group number equals 1.

18. The non-transitory computer-readable medium of claim 10, wherein the storing comprises transposing the tile.

19. A system, comprising:
a host; and
an accelerator, connected to the host,
the host being configured to
store a tile of a tensor in a memory of the accelerator,
the storing comprising:
rearranging the tile to generate a rearranged tile, and
storing a first vector of the tile and a second vector of the tile in contiguous memory locations.

20. The system of claim 19, wherein the host is further configured to:
store the first vector and the second vector in a first portion of the memory,
the first portion of the memory being an activation unit of the memory.
